(19) United States
(12) Patent Application Publication
(10) Pub. No.: US 2026/0369049 A1
(43) Pub. Date: Nov. 19, 2026

(54) ADAPTIVE SAMPLING METHOD IN DVS EVENT-BASED CNN-SNN MODEL AND METHOD FOR PRESERVING REDUNDANT INFORMATION

(71) Applicant: KWANGWOON UNIVERSITY INDUSTRY-ACADEMIC COLLABORATION FOUDATION, Seoul (KR)

(72) Inventors: Dong Gyu SIM, Seoul (KR); Young Bok LEE, Seoul (KR)

(21) Appl. No.: 19/143,355

(22) PCT Filed: Oct. 25, 2023
(86) PCT No.: PCT/KR2023/016688

§ 371 Date: Jun. 25, 2025

(30) Foreign Application Priority Data
Dec. 26, 2022 (KR) 10-2022-0184521

(51) Int. Cl. G06V 10/84; G06V 20/40; G06V 20/52

(52) U.S. Cl. CPC G06V 10/84; G06V 20/44; G06V 20/52

(57) ABSTRACT

A method and an apparatus for processing a cumulative event signal are disclosed in the present disclosure. The method may comprise: a sampling determination step of determining whether exception event sampling is applied or context event sampling is applied to a cumulative event signal; a step of sampling an exception event signal and a context event signal from an event frame on the basis of probability information; an exception event sampling step of sampling the exception event signal from a cumulative event when the exception event sampling is applied to the cumulative event signal; an abnormal object detection step of detecting an abnormal object for the sampled exception event signal; and an abnormal object risk determination step of determining risk of the detected abnormal object.

### TECHNICAL FIELD

The present invention relates to a technology for adaptively sampling an event frame according to the real-time road driving system application in order to efficiently process an event signal that can be obtained at a short interval, and relates to an event signal-based adaptive sampling method and a CNN-SNN neural network-based feature interpolation technology to preserve temporal information between sampled frames.

### BACKGROUND ART

An event acquisition signal may be accumulated for a certain period of time according to the computing operation time that requires a relatively long time compared to an event acquisition signal.

### DISCLOSURE

### Technical Problem

The present invention may efficiently adjust an event signal cumulative interval suitable for a real-time environment through a probability-based model and minimize information loss that may occur due to sampling through the estimation of redundant information that is not sampled through an interpolation step between spatial features.

### Technical Solution

As a means for achieving the above-described technical problem, the DVS event-based adaptive sampling method of the present invention is a system based on the probability information of past signals, which performs a sampling step suitable for a necessary application among the exception event and context event applications. It detects whether a real-time exception event occurs and immediately performs event object detection within an exception event frame without waiting for a predefined cumulative time when an exception event occurs. When an exception event does not occur, a sampling method is performed to analyze context information on an event signal that occurs for a certain period of time. However, in order to preserve the temporal information of a frame lost in a sampling step, a spatial feature vector interpolation method is performed after a CNN network in a CNN-RNN model.

The cumulative event signal processing method and device of the present disclosure includes a sampling determination step for determining whether exception event sampling is applied or context event sampling is applied to a cumulative event signal, a step for sampling an exception event signal and a context event signal from an event frame based on probability information, an exception event sampling step for sampling the exception event signal from the cumulative event when the exception event sampling is applied to the cumulative event signal, an abnormal object detection step for detecting an abnormal object for the sampled exception event signal and an abnormal object risk determination step for determining a risk of the detected abnormal object, wherein the exception event sampling may be performed by comparing a sum value of the cumulative event signal obtained based on the probability information of the cumulative event signal with the exception event cumulative threshold, and the exception event cumulative event may be any one of a cumulative threshold of an initially set first exception event or a cumulative threshold of a second exception event obtained as a system result for a previous cumulative event signal.

In the cumulative event signal processing method and device of the present disclosure, the exception event cumulative threshold is adjusted based on the risk.

In the cumulative event signal processing method and device of the present disclosure, when the context event sampling is applied to the cumulative event signal, the context event sampling may be performed on the cumulative event to sample the context event signal, and the context event sampling may be performed by selecting any one of a hierarchical uniform interval sampling method or an adaptive non-uniform interval sampling method.

In the cumulative event signal processing method and device of the present disclosure, the hierarchical uniform interval sampling may be performed by wide uniform interval sampling or narrow uniform interval sampling, and the wide uniform interval sampling may sample a frame at a relatively wide uniform time interval that is initially set without considering the probability distribution, and the narrow uniform interval sampling may perform sampling at a relatively narrow uniform time interval based on the sum value of the cumulative event signal.

### Advantageous Effect

The present invention may perform sampling based on the amount of motion without a separate additional extraction process compared to a sampling method using the difference value of optical flow and color information. A sampling method may be divided into an exceptional situation handling mode and a road situation context identification mode, and a system may select a sampling method according to a priority and adjust it according to the limited computing operation quantity and the operation speed. Afterwards, information on the time lost due to adaptive sampling may be compensated through feature interpolation for a spatial feature in a CNN-RNN model.

### BRIEF DESCRIPTION OF DRAWINGS

FIG. 1 conceptually shows a process for selecting a cumulative event signal sampling method of the present

FIG. 2 shows a process for performing the exception event sampling step of the present disclosure.

FIG. 3 shows a process for performing the hierarchical uniform interval sampling step of the present disclosure.

FIG. 4 shows a process for performing the adaptive non-uniform interval sampling step of the present disclosure.

FIG. 5 shows the sampled event signal-based CNN-SNN model and feature interpolation process of the present disclosure.

FIG. 6 shows an example of uniform time interval frame sampling of the present disclosure.

FIG. 7 shows a method for performing the adaptive non-uniform time interval frame sampling step of FIG. 4 as an embodiment of the present disclosure.

FIG. 8 shows a process for performing the sampled event signal-based CNN-SNN model and feature interpolation process of FIG. 5 as an embodiment of the present disclosure.

FIG. 9 shows the network configuration of an UNET-based Frame Rate Up Conversion model and an extracted result through a time axis RNN network.

### BEST MODEL

The cumulative event signal processing method and device of the present disclosure includes a sampling determination step for determining whether exception event sampling is applied or context event sampling is applied to a cumulative event signal, a step for sampling an exception event signal and a context event signal from an event frame based on probability information, an exception event sampling step for sampling the exception event signal from the cumulative event when the exception event sampling is applied to the cumulative event signal, an abnormal object detection step for detecting an abnormal object for the sampled exception event signal and an abnormal object risk determination step for determining a risk of the detected abnormal object, wherein the exception event sampling may be performed by comparing a sum value of the cumulative event signal obtained based on the probability information of the cumulative event signal with the exception event cumulative threshold, and the exception event cumulative event may be any one of a cumulative threshold of an initially set first exception event or a cumulative threshold of a second exception event obtained as a system result for a previous cumulative event signal.

### Mode for Invention

Hereinafter, referring to attached drawings, the embodiment of the present invention will be described in detail so that those skilled in the art may easily implement it in the technical field to which the present invention belongs. However, the present invention may be implemented in different forms and is not limited to embodiments described herein. In addition, in order to clearly explain the present invention in drawings, parts that are not related to the description are omitted, and similar drawing signs are attached to similar parts throughout the specification.

Throughout the specification, when a part is said to be connected to another part, it includes not only a case where it is directly connected, but also a case where it is electrically connected with other elements in between. In addition, when a part is said to include a component, it means that instead of excluding other components, other components may be further included, unless otherwise specifically opposed.

Throughout the specification, when a part is said to include a component, it means that instead of excluding other components, other components may be further included, unless otherwise specifically opposed. The term of degree such as ‘step for ~’ or ‘step of~’ used throughout the specification does not mean a step for ~.

In addition, although terms ‘first’, ‘second’, etc. may be used to describe various components, the components should not be limited by the terms. The terms are used only to distinguish one component from other components.

In addition, as construction units shown in an embodiment of the present disclosure are independently shown to represent different characteristic functions, it does not mean that each construction unit is composed in a construction unit of separate hardware or one software. In other words, as each construction unit is described by being enumerated as each construction unit for convenience of a description, at least two construction units of each construction unit may be combined to form one construction unit or one construction unit may be divided into a plurality of construction units to perform a function. An integrated embodiment and a separate embodiment of each construction unit are also included in a scope of a right of the present disclosure unless they are beyond the essence of the present disclosure.

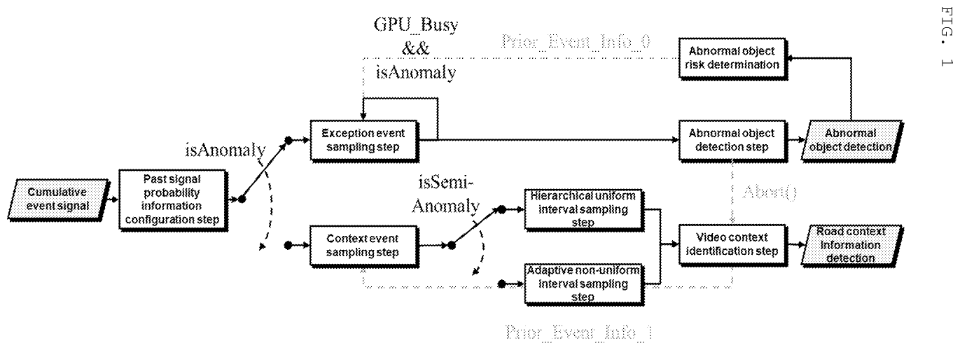

FIG. 1 may show a method for performing sampling of a cumulative event signal.

An event signal accumulator may select and perform an exception event sampling method and a context event sampling method according to whether a cumulative event signal is classified as an exception event or a context event. The sampling may be performed by the event sampler (or event sampling module) of a signal accumulator.

When a cumulative event signal is classified as an exception event, an abnormal object detection module for a cumulative event signal may be performed. The abnormal object detection may be performed to determine the risk of a detected abnormal object and adjust the cumulative threshold of an exception event signal. The object detection and risk determination may be performed by the object detection and risk determiner (or object detection and risk determination module) of the event signal accumulator.

When a cumulative event signal is classified as a context event, sampling for a context event signal may be performed. The sampling may be performed by selecting any one of a hierarchical uniform interval sampling method or an adaptive non-uniform interval sampling method. In addition, a video context identification module that identifies the context of an image through a cumulative event sampled as a context event may be performed. When a video context identification step is performed by a video context identification module that uses a cumulative event sampled as a context event as an input, road context information may be detected.

A video context identification module may stop performing a video context identification step when an abnormal object detection step is enabled, and may continuously perform a video context identification step when an abnormal object detection step is disabled.

The past signal probability information configuration step of FIG. 1 may obtain an event signal at a certain time interval to configure the probability information of the past event signal. The probability information may be a basis for exception event sampling or context event sampling.

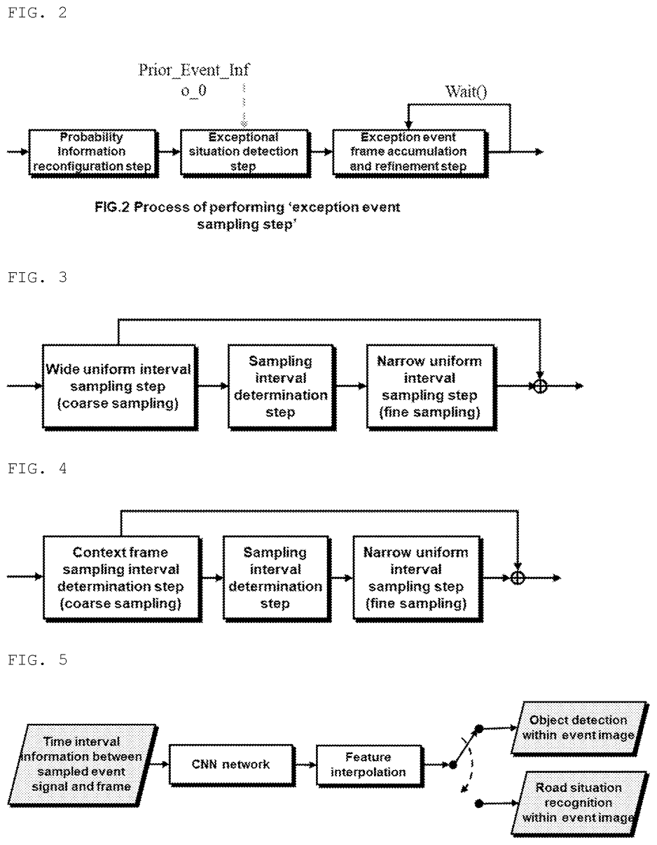

FIG. 2 shows a process for performing the exception event sampling step of the present invention.

The probability distribution of an event signal that occurs during a time interval adjusted through the feedback of an initially set or previous system result may be reconfigured. A module that determines whether an obtained event signal is an exceptional event signal based on reconfigured probability information may be performed.

The probability information reconfiguration step of FIG. 2 may draw a probability distribution function for the sum value of an event signal in a frame that occurs within a recent certain time and the frequency of a frame with a corresponding value. In a drawn probability distribution function, frames having an event signal sum value that is far from the average may be defined as an exception event occurrence duration.

The exceptional situation detection step of FIG. 2 may determine whether it is an exceptional situation by comparing a real-time cumulative event signal sum value with an exception event signal sum value to determine whether they are the same.

The exception event frame refinement and accumulation step of FIG. 2 may perform noise removal on a sampled exception event frame. A frame classified as an exception event may be accumulated while waiting for a certain period of time.

FIG. 3 shows a process for performing the hierarchical uniform interval sampling step of the present invention.

The ‘wide uniform interval sampling step’ of FIG. 3 may sample a frames at an initially set wide uniform time interval without considering the probability distribution.

The ‘sampling interval determination step’ of FIG. 3 may obtain a time interval to be applied in a subsequent narrow uniform interval sampling step based on an event signal sum value within a sampled frame. Here, an event signal sum value may be determined by considering the probability distribution.

The ‘narrow uniform interval sampling step’ of FIG. 3 may sample a frame duration with a large sampled event signal sum value again at a narrow uniform interval.

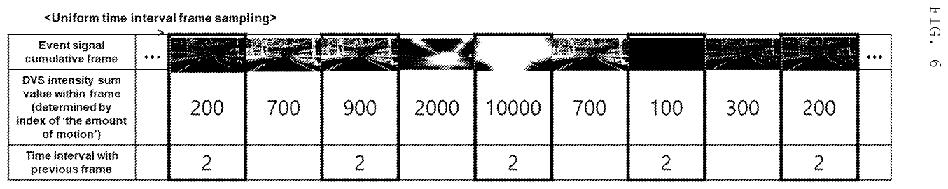

FIG. 4 shows a process for performing the adaptive non-uniform interval sampling step of the present invention.

The ‘context frame sampling interval determination step’ of FIG. 4 may draw a cumulative distribution function for the sum value of an event signal in a frame and the frequency of a frame with a corresponding value by referring to the information of a pre-configured past event signal. The frame frequency of a drawn cumulative distribution function may be divided at a uniform interval to obtain an event signal sum value corresponding to the closest frame frequency and sample a frame with a corresponding sum value.

The ‘sampling interval determination step’ of FIG. 4 may determine a narrower sampling interval as a time interval between sampled frames is wider, and may determine a wider sampling interval as a time interval between sampled frames is narrower.

The ‘narrow uniform interval sampling step’ of FIG. 4 may sample a frame interval sampled based on a pre-determined sampling interval at a narrower uniform interval.

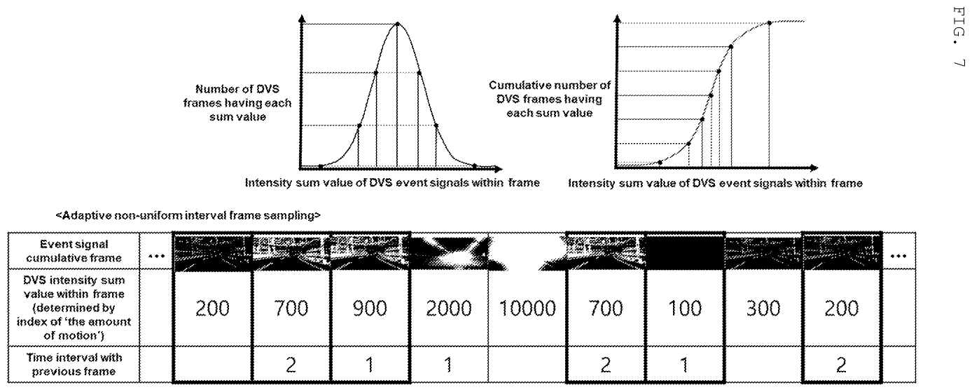

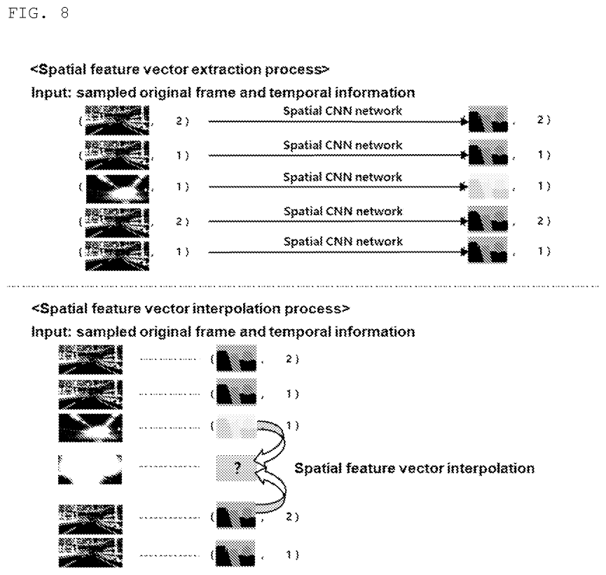

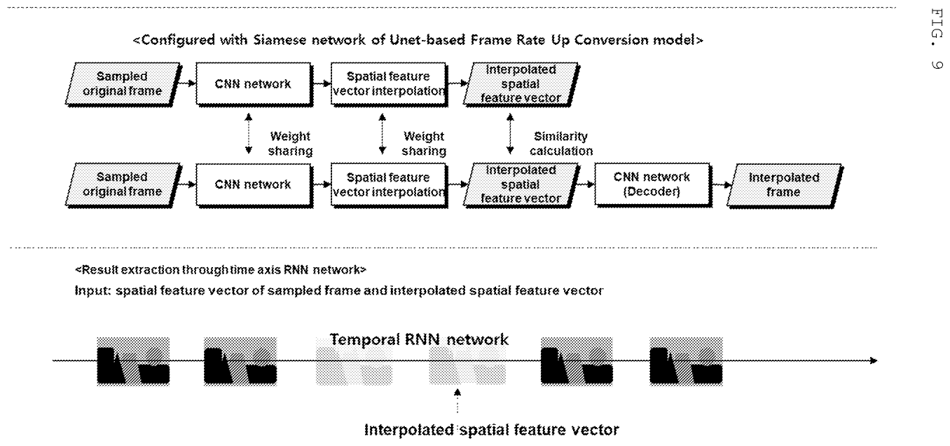

FIG. 5 shows the sampled event signal-based CNN-SNN model and feature interpolation process of the present invention.

FIG. 5 may represent an object detection and road condition recognition method using a CNN-SNN model based on a sampled event signal and a feature interpolation method to prevent temporal information loss that may occur during sampling. A sampled event signal may extract a feature vector through a spatial axis CNN network for each frame. The time interval information between sampled event frames may be input together to a CNN network. The interval of feature vectors extracted through a sampled event CNN network may be interpolated based on time interval information between transmitted event signals. The spatial feature vectors of a sampled event frame and interpolated feature vectors may be temporally processed through one RNN model for object detection and road condition recognition.

The exemplary methods of the present disclosure are described as a series of operations for clarity of explanation, but this is not intended to limit the order in which the steps are performed, and when necessary, each step may be performed simultaneously or in a different order. In order to implement a method according to the present disclosure, another step may be additionally included in an exemplary step or the remaining steps may be included excluding some steps or another additional step may be included excluding some steps.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAS (Field Programmable Gate Arrays), general processors, controllers, microcontrollers, microprocessors, etc.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

### INDUSTRIAL APPLICABILITY

The present disclosure may be utilized in the cumulative event signal processing field.

1. A cumulative event signal processing method, the method comprising:
a sampling determination step for determining whether an exception event sampling is applied or a context event sampling is applied to a cumulative event signal;
a step for sampling an exception event signal and a context event signal from an event frame based on probability information;
an exception event sampling step for sampling the exception event signal from the cumulative event when the exception event sampling is applied to the cumulative event signal;
an abnormal object detection step for detecting an abnormal object for the sampled exception event signal; and
an abnormal object risk determination step for determining a risk of the detected abnormal object,
wherein the exception event sampling is performed by comparing a sum value of the cumulative event signal obtained based on probability information of the cumulative event signal with the exception event cumulative threshold, and
wherein the exception event cumulative event is any one of a cumulative threshold of an initially set first exception event or a cumulative threshold of a second exception event obtained as a system result for a previous cumulative event signal.

2. The method of claim 1, wherein:
the exception event cumulative threshold is adjusted based on the risk.

3. The method of claim 1, wherein:
when the context event sampling is applied to the cumulative event signal, the context event sampling is performed on the cumulative event to sample the context event signal, and
the context event sampling is performed by selecting any one of a hierarchical uniform interval sampling or an adaptive non-uniform interval sampling method.

4. The method of claim 3, wherein:
the hierarchical uniform interval sampling is performed by a wide uniform interval sampling or a narrow uniform interval sampling,
the wide uniform interval sampling samples a frame at a relatively wide uniform time interval that is initially set without considering the probability distribution, and
the narrow uniform interval sampling performs a sampling at a relatively narrow uniform time interval based on the sum value of the cumulative event signal.

5. A cumulative event signal processing device, the device comprising:
an event sampler for determining whether an exception event sampling is applied or a context event sampling is applied to a cumulative event signal, and sampling an exception event signal from the cumulative event when the exception event sampling is applied to the cumulative event signal; and
an object detection and risk determiner for detecting an abnormal object for the sampled exception event signal, and determining a risk of the detected abnormal object,
wherein the exception event sampling is performed by comparing a sum value of the cumulative event signal obtained based on probability information of the cumulative event signal with the exception event cumulative threshold, and
wherein the exception event cumulative event is any one of a cumulative threshold of an initially set first exception event or a cumulative threshold of a second exception event obtained as a system result for a previous cumulative event signal.

6. The device of claim 5, wherein:
the exception event cumulative threshold is adjusted based on the risk.

7. The device of claim 5, wherein:
when the context event sampling is applied to the cumulative event signal, the context event sampling is performed on the cumulative event to sample the context event signal, and
the context event sampling is performed by selecting any one of a hierarchical uniform interval sampling or an adaptive non-uniform interval sampling method.

8. The device of claim 7, wherein:
the hierarchical uniform interval sampling is performed by a wide uniform interval sampling or a narrow uniform interval sampling,
the wide uniform interval sampling samples a frame at a relatively wide uniform time interval that is initially set without considering the probability distribution, and
the narrow uniform interval sampling performs a sampling at a relatively narrow uniform time interval based on the sum value of the cumulative event signal.
